(19) United States
(12) Patent Application Publication
(10) Pub. No.: US 2012/0325027 A1
(43) Pub. Date: Dec. 27, 2012

(54) MEASUREMENT STAGE WITH TUBE CARRIER

(75) Inventors: Alexander Cooper, Belmont, CA (US); Michael B. Binnard, Belmont, CA (US)

(73) Assignee: NIKON CORPORATION, Tokyo (JP)

(21) Appl. No.: 13/526,322

(22) Filed: Jun. 18, 2012

Related U.S. Application Data
(60) Provisional application No. 61/499,373, filed on Jun. 21, 2011.

(51) Int. Cl. G01D 21/00

(52) U.S. Cl. 73/865.8

(57) ABSTRACT

In one embodiment, a stage apparatus includes a wafer stage, at least one conduit, and a measurement stage. The at least one conduit is coupled between the wafer stage and a ground. The measurement stage is configured to approximately follow the wafer stage during at least a portion of a motion of the wafer stage, and is configured to carry the at least one conduit to reduce disturbances on the wafer stage caused by the at least one conduit.

### CROSS REFERENCE TO RELATED APPLICATION

The present applications claim benefit under 35 U.S.C. §119(e) of U.S. Provisional Patent Application No. 61/499,373 entitled “Measurement Stage as Tube Carrier,” filed Jun. 21, 2011, which is incorporated herein by reference in its entirety.

### BACKGROUND OF THE INVENTION

1. Field of the Invention

The present invention relates generally to equipment used in semiconductor processing. More particularly, the present invention relates to using a measurement stage to carry or otherwise supports cables and/or tubes associated with an exposure stage assembly.

2. Description of the Related Art

Cables and tubes, e.g., hoses, associated with an exposure stage assembly may provide electrical power, electronic signals, pneumatic, vacuum, and/or hydraulic supply and return, and cooling to motion stages. Often, cables and tubes may have an adverse impact on the operation of an exposure stage. Cables and tubes may cause disturbance forces that affect a stage, and may transmit vibrations to the motion stage. Both disturbance forces and vibrations may have a negative effect on the overall performance of an exposure stage. For example, cables and tubes often have relatively large inertial masses associated therewith, and may disturb the motion of an exposure stage from a desired trajectory, and may additionally transmit vibrations to the stage.

A tube carrier may be used to reduce disturbances associated with cables and tubes. Generally, a tube carrier guides cables and tubes so that they follow an exposure stage closely and do not impart a significant amount of disturbances. The tube carrier generally accelerates with the exposure stage, and absorbs unwanted disturbance forces from the cables and the tubes.

To reduce disturbances on exposure stages that are due at least in part to cables and tubes, a tube carrier may be powered. That is, a dedicated powered tube carrier may be used to carry or to otherwise support, as well as to guide, tubes and hoses. While such a tube carrier may be effective, the implementation of the tube carrier may be relatively complicated, and the tube carrier may utilize a significant amount of space, i.e., have a significant footprint. The tube carrier typically must move as fast as an exposure stage and must move very precisely also so that the tube carrier may track the motion of the exposure stage. Further, the tube carrier and its additional power and control systems increase overall system cost and complexity.

### SUMMARY

The present invention pertains to a system which allows a measurement stage of an overall stage assembly to carry cables and tubes associated with a wafer stage, e.g., a precision stage, of the overall stage assembly. The measurement stage typically includes components which allow measurements of system characteristics to be taken, while effectively also serving as a tube carrier stage. In alternate embodiments, a measurement stage may serve a purpose that is different from obtaining measurements in addition to, or in lieu of, the purpose of obtaining measurements.

According to one aspect, a stage apparatus includes a wafer stage, at least one conduit, and a measurement stage. The at least one conduit is coupled between the wafer stage and a surface, e.g., a ground or a countermass. The measurement stage is configured to approximately follow the wafer stage during at least a portion of a motion of the wafer stage, and is configured to carry the at least one conduit to reduce disturbances on the wafer stage caused by the at least one conduit. In one embodiment, the measurement stage includes a tube carrier assembly arranged to couple the at least one conduit to the measurement stage. In such an embodiment, the tube carrier assembly may be a slider arrangement that includes a rail and a slider configured to slide along the rail, where the at least one conduit is coupled to the slider.

In accordance with another aspect, a stage apparatus includes a first stage and at least one selected from a group including a cable and a tube. The at least one selected from the group including the cable and the tube is coupled between the first stage and a ground or a countermass. The stage apparatus also includes a second stage configured to follow the first stage at a first time during an overall exposure process when the first stage travels and to perform measurements of system characteristics. The second stage is further configured to carry the at least one selected from the group including the cable and the tube to reduce disturbances on the first stage caused by the at least one selected from the group including the cable and the tube.

According to still another aspect, a method for operating a stage apparatus that has a wafer stage and a measurement stage configured to take measurements, e.g., measurements associated with the wafer stage, includes scanning the wafer stage. Scanning the wafer stage causes a conduit between the wafer stage and a ground to move. The method also includes moving the measurement stage such that the measurement stage follows the wafer stage, wherein the measurement stage is configured to support the conduit to reduce disturbances associated with the conduit when the conduit moves due to the wafer stage scanning.

### BRIEF DESCRIPTION OF THE DRAWINGS

The invention will be readily understood by the following detailed description in conjunction with the accompanying drawings, in which:

FIG. 1 is diagrammatic representation of an overall stage device within which a measurement stage supports at least one cable or tube associated with a wafer or exposure stage in accordance with an embodiment of the present invention.

FIG. 2A is a diagrammatic top view representation of a wafer stage and a measurement stage in which the measurement stage supports a cable or tube that stretches as a wafer stage moves in accordance with an embodiment of the present invention.

FIG. 2B is a diagrammatic top view representation of a wafer stage and a measurement stage, e.g., wafer stage 204 and measurement stage 208 of FIG. 2A, at a time t1 at which the wafer stage and the measurement stage are in relatively close proximity in accordance with an embodiment of the present invention.

FIG. 2C is a diagrammatic top view representation of a wafer stage and a measurement stage, e.g., wafer stage 204 and measurement stage 208 of FIG. 2A, at a time t2 at which the wafer stage and the measurement stage are relatively far apart in accordance with an embodiment of the present invention.

FIG. 3 is diagrammatic representation of an overall stage device within which a measurement stage with a slider arrangement supports at least one cable or tube associated with a wafer stage in accordance with an embodiment of the present invention.

FIG. 4A is a diagrammatic top view representation of a wafer stage and a measurement stage in which the measurement stage supports a cable or tube using a slider arrangement in accordance with an embodiment of the present invention.

FIG. 4B is a diagrammatic top view representation of a wafer stage and a measurement stage, e.g., wafer stage 404 and measurement stage 408 of FIG. 4A, at a time t1 at which the wafer stage and the measurement stage are in relatively close proximity in accordance with an embodiment of the present invention.

FIG. 4C is a diagrammatic top view representation of a wafer stage and a measurement stage, e.g., wafer stage 404 and measurement stage 408 of FIG. 4A, at a time t2 at which the wafer stage and the measurement stage are relatively far apart in accordance with an embodiment of the present invention.

FIG. 5 is diagrammatic top view representation of an overall stage device within which a measurement stage with an associated linkage supports at least one cable or tube associated with a wafer stage in accordance with an embodiment of the present invention.

FIG. 6A is a diagrammatic side view representation of a measurement stage on which a tube carrier arrangement is mounted in accordance with an embodiment of the present invention.

FIG. 6B is a diagrammatic cross-sectional side view representation of a measurement stage, e.g., measurement stage 608 of FIG. 6A, in accordance with an embodiment of the present invention.

FIG. 7 is a diagrammatic representation of a photolithography apparatus in accordance with an embodiment of the present invention.

FIG. 8 is a process flow diagram which illustrates the steps associated with fabricating a semiconductor device in accordance with an embodiment of the present invention.

FIG. 9 is a process flow diagram which illustrates the steps associated with processing a wafer, i.e., step 1104 of FIG. 3, in accordance with an embodiment of the present invention.

### DETAILED DESCRIPTION OF THE EMBODIMENTS

Example embodiments of the present invention are discussed below with reference to the various figures. However, those skilled in the art will readily appreciate that the detailed description given herein with respect to these figures is for explanatory purposes, as the invention extends beyond these embodiments.

One consideration in a successful precision stage design, e.g., a stage design that uses a planar motor, is how to handle the electrical, cooling and other cables that connect to an exposure stage such as a precision stage to supply utilities, power, control signals, and measurement signals. Disturbances from cables and tubes or hoses moving during stage motion may have an adverse impact on the motion of an exposure stage. Such disturbances may compromise the accuracy with which the exposure stage may be positioned, and generally compromise overall system performance.

In one embodiment, a measurement stage of an overall stage assembly may be used as a tube carrier. That is, a measurement stage may be used for measurement purposes and for tube carrying purposes. A measurement stage may already be present in a machine design, e.g., an overall stage apparatus or photolithography system, and substantially capable of effectively serving the same function as a dedicated tube carrier. In operation, as will be appreciated by those skilled in the art, a measurement stage typically follows a wafer or exposure stage relatively closely at least some of the time, e.g., at certain times. As such, an operation mode of the measurement stage would generally not need to be significantly altered to substantially function as a tube carrier, although in some instances, the stroke of the measurement stage may be slightly bigger may have a higher duty cycle, e.g., may operate at a relatively high acceleration more frequently. It should be understood that a substantial number of the measurements made with a measurement stage may be made at relatively low speeds, or while the measurement stage is substantially stationary, thereby substantially minimizing cable movement.

In general, a measurement stage closely follows a wafer stage, and accelerates with the wafer stage at certain times during the operation of an overall stage apparatus. When the measurement stage closes follows the wafer stage, a cable and/or tube carried by the measurement stage generally does not impart a significant amount of disturbances on the wafer stage. Additionally, as many measurements taken by the measurement stage may be made when the measurement stage is moving at relatively low speeds, and/or while the measurement stage is substantially stationary, the impact of cable-related and/or tube-related disturbances on the measurement stage are generally not significant.

Within an overall stage apparatus, when a measurement stage is not closely following a wafer stage, the measurement stage may not be in relatively close proximity to the wafer stage. That is, at some times during a fabrication process, a measurement stage and a wafer stage may be relatively far apart. When a measurement stage and a wafer stage are relatively far apart, as for example when a wafer is being loaded onto or unloaded from the wafer stage, a tube carrier portion of the measurement stage allows cables and/or tubes supported by the measurement stage to remain coupled to the wafer stage without significantly compromising the performance of the wafer stage. In other words, a measurement stage that has tube carrier features is generally configured to allow cables and/or tubes carried by the tube carrier to remain coupled to a wafer stage without causing significant disturbances to the wafer stage even when the measurement stage and the wafer stage are not in relatively close proximity.

By using a measurement stage as a tube carrier, the design of an overall stage assembly is effectively simplified while reducing disturbances imparted by cables and tubes, as the need for a separate tube carrier is substantially eliminated. As a measurement stage is often already a part of an overall stage assembly, the costs and footprint associated with substantially utilizing the measurement stage as a tube carrier may be lower than the costs and footprint associated with utilizing a dedicated tube carrier. That is, augmenting a measurement stage to carry tubes is generally less costly and less space-consuming than implementing a separate tube carrier to carry cables and tubes. In general, relatively minimal additional components may be needed to enable a measurement stage to also function as a tube carrier. Additional components used to enable a measurement stage to carry tubes generally do not significantly increase the size of, e.g., the footprint of, the measurement stage.

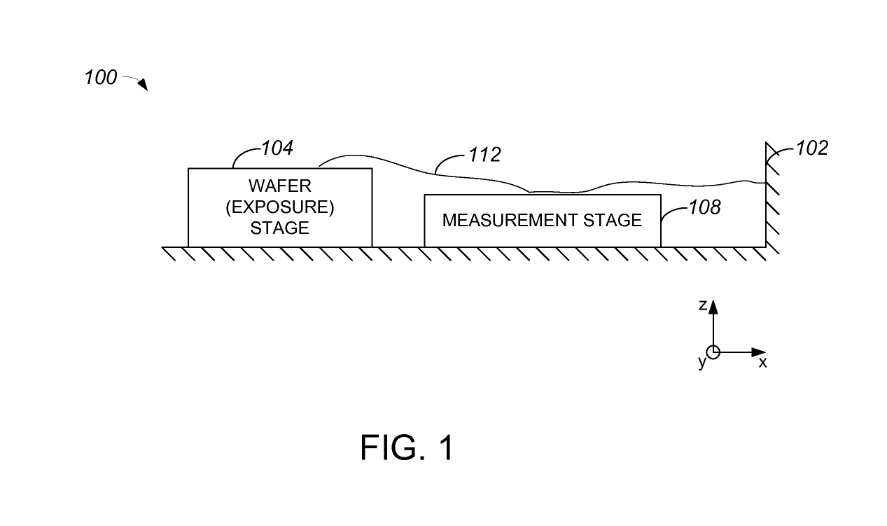

Referring initially to FIG. 1, an overall stage device within which a measurement stage supports at least one cable or tube associated with a wafer or exposure stage will be described in accordance with an embodiment of the present invention. An overall stage device 100 includes a wafer or exposure stage 104, which is generally arranged to support a wafer (not shown), and a measurement stage 108. As will be appreciated by those skilled in the art, wafer stage 104 and measurement stage 108 are generally driven by actuators (not shown). In the described embodiment, wafer stage 104 is driven by a planar motor (not shown). It should be appreciated, however, that wafer stage 104 is not limited to being driven by a planar motor. By way of example, wafer stage 104 may be driven by any suitable actuator including, but not limited to including, a linear motor.

At least one cable or tube 112 is substantially coupled between a ground 102 or, more generally, a surface associated with overall stage device 100 that moves significantly less than wafer stage 104, e.g., a fixed surface or a countermass associated with overall stage device 100. The at least one cable or tube 112 is arranged to supply, in one embodiment, electrical power and/or cooling to wafer or exposure stage 104. The at least one cable or tube 112 is arranged to be supported by measurement stage 108 such that the at least one cable or tube 112 is moved by measurement stage 108. For example, when measurement stage 108 translates, the at least one cable or tube 112 moves. For ease of discussion, a cable and/or a tube will generally be referred to as a conduit. It should be appreciated that while a conduit generally includes cables, hoses, pipes, and/or tubes, a conduit is not limited to including cables, hoses, pipes, and/or tubes. By way of example, a conduit may also include at least one wire.

In general, a measurement stage that is configured to perform measurements and to serve as a tube carrier may b include a component, e.g., a mechanical coupler or fastener, that effectively supports at least a part of a conduit with respect to the measurement stage. That is, a measurement stage may essentially serve as a point of contact or support for a conduit that is arranged between a source, e.g., a supply of a resource that is to be carried by the conduit, and a wafer stage.

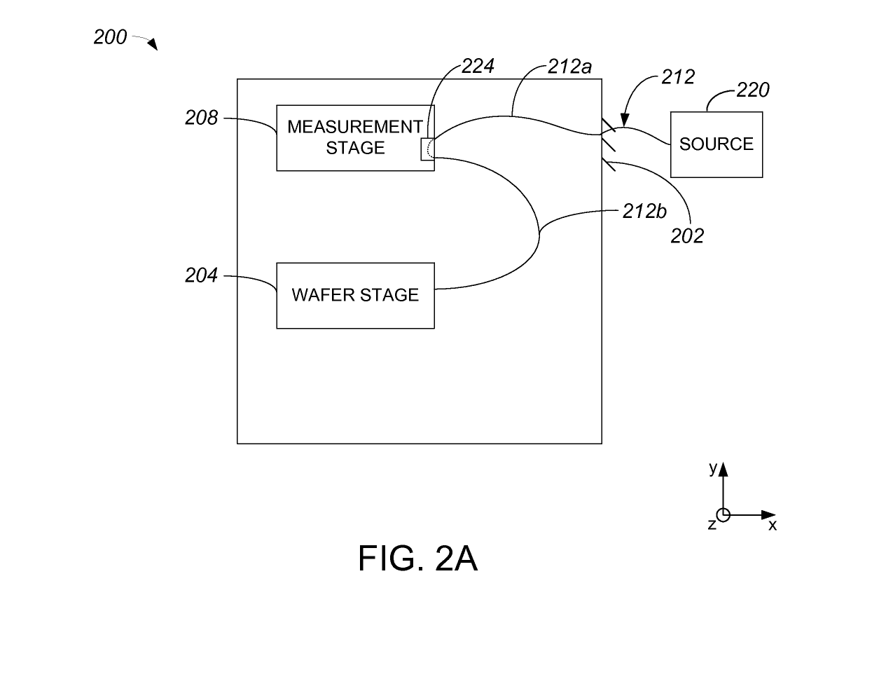

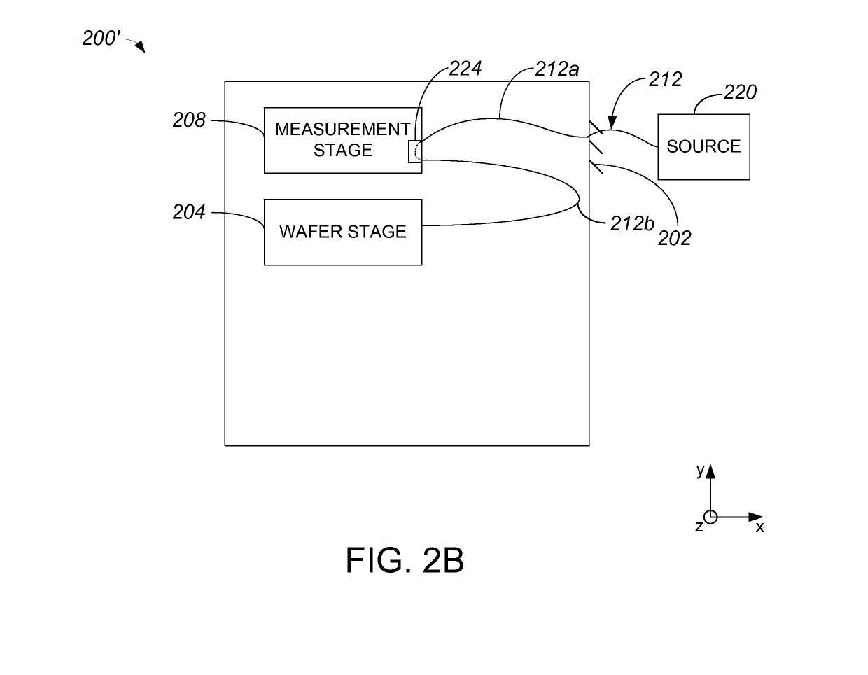

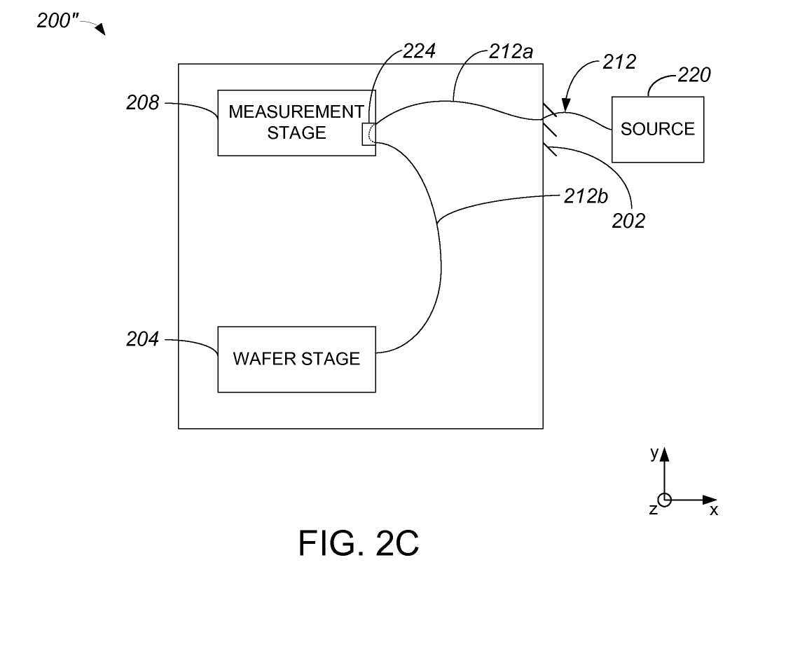

In one embodiment, a conduit between a source and a wafer stage may be supported by a measurement stage such that the conduit effectively stretches as the wafer stage moves away from the measurement stage. FIG. 2A is a diagrammatic top view representation of a wafer stage and a measurement stage in which the measurement stage supports a conduit that effectively stretches as a wafer stage moves in accordance with an embodiment of the present invention. An overall stage apparatus 200 includes a wafer stage 204 arranged to carry a wafer (not shown). In one embodiment, wafer stage 204 is driven by a planar motor (not shown). A measurement stage 208 is arranged to translate and to accelerate with wafer stage 204.

At least one conduit arrangement 212, e.g., at least one cable or tube, may be arranged to essentially couple a source 220 to wafer stage 204. It should be appreciated that conduit arrangement 212 may also be coupled to a ground 202, e.g., a countermass, or source 220 may effectively be a ground. Conduit arrangement 212 may provide fluid and/or power or signals, e.g., electricity, from source 220 to wafer stage 204. Fluid provided by conduit arrangement 212 may include, but is not limited to including, a cooling fluid, pressurized air, and/or a vacuum. A first portion 212a of conduit arrangement 212 is arranged between source 220 and measurement stage 208, while a second portion 212b of conduit arrangement 212 is arranged between measurement stage 208 and wafer stage 204. It should be appreciated that first portion 212a and second portion 212b may be contiguous, or first portion 212a and second portion 212b may be separate pieces that are effectively coupled together at measurement stage 208.

A tube carrier assembly 224 is a part of, or is attached to, measurement stage 208. Tube carrier assembly 224 carries conduit arrangement 212 while substantially absorbing disturbance forces associated with the movement of first portion 212a. That is, conduit arrangement 212 is coupled to measurement stage 208 by tube carrier assembly 224 and substantially all disturbance forces generated by first portion 212a may be absorbed by measurement stage 208. Second portion 212b of conduit arrangement 212 is relatively flexible. As such, second portion 212b of conduit arrangement 212 is arranged to contract, by decreasing the curvature of second portion 212b, as a distance between wafer stage 204 and measurement stage 208 decreases, and to stretch or extend, by increasing the curvature of second portion 212b, as the distance between wafer stage 204 and measurement stage 208 increases.

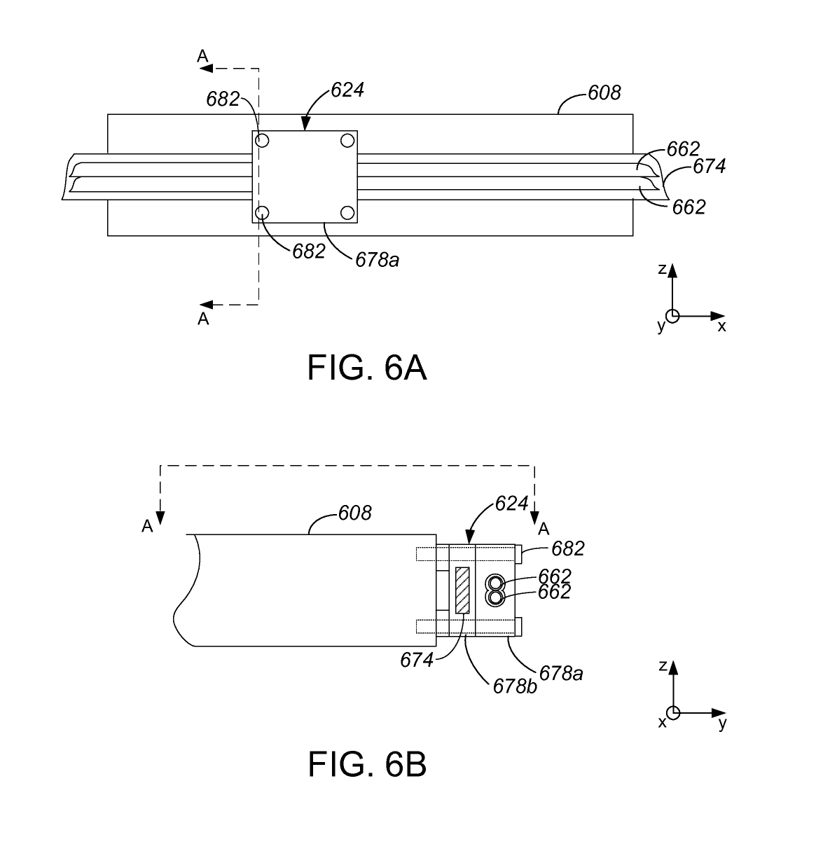

Tube carrier assembly 224 may be any assembly that substantially secures conduit arrangement 212 to measurement stage 208 such that conduit arrangement 212 may move with measurement stage 208. One embodiment of tube carrier assembly 224 will be described below with reference to FIGS. 6A and 6B. When measurement stage 208 is in relatively close proximity to wafer stage 204 and moves with wafer stage 204, disturbance forces from first portion 212a may be absorbed by measurement stage 208, and second portion 212b may maintain a substantially constant configuration so as not to create substantial disturbance forces acting on wafer stage 204. Tube carrier assembly 224 thereby reduces the effect on wafer stage 204 from disturbances associated with conduit arrangement 212.

FIG. 2B is a diagrammatic top view representation of wafer stage 204 and measurement stage 208 at a time t1 at which the wafer stage and the measurement stage are in relatively close proximity in accordance with an embodiment of the present invention. At a time t1, within overall stage assembly 200′, measurement stage 208 is in relatively close proximity to wafer stage 204. As such, second portion 212b is not stretched or extended. In the described embodiment, measurement stage 208 may be in relatively close proximity to wafer stage 204 when wafer stage 204 is in operation mode, e.g., during exposure. When wafer stage 204 is in operation mode, disturbances associated with conduit arrangement 212 may effectively be minimized because measurement stage 208 moves together with wafer stage 204.

At a time t2, as shown in FIG. 2C, wafer stage 204 and measurement stage 208 of overall stage assembly 200″ are relatively far apart. Typically, wafer stage 204 and measurement stage 208 may be relatively far apart when wafer stage 204 is not in operation mode, e.g., before or after exposure, or is in a less critical phase of operation, such as wafer exchange. During a less critical phase of operation, the tolerance on wafer stage 204 for disturbances caused by movement associated with second portion 212b of conduit arrangement 212 may be higher. For example, the effect of vibrations of second portion 212b of conduit arrangement 212 on the performance of overall stage assembly 200 may be tolerable when wafer stage 204 is in a less critical phase of operation.

Typically, when wafer stage 204 is operating at a relatively high level of accuracy, e.g., during exposure as shown in FIG. 2B, measurement stage 208 may follow wafer stage 204 relatively closely, and second portion 212b may be maintained in a substantially fixed configuration such that disturbances or forces provided by second portion 212b may be substantially constant and unvarying. Preferably, second portion 212 may be relatively short.

When wafer stage 204 and measurement stage 208 are relatively far apart for operational reasons, as for example during wafer exchange, second portion 212b may stretch or compress as accuracy within overall stage assembly 200″ may be less critical. During times when wafer stage 204 and measurement stage 208 are relatively far apart, measurement stage 208 may be obtaining measurements of a projection lens (not shown) or other system characteristics at a relatively low velocity or when measurement stage 208 is stationary. When measurement stage 208 is moving at a relatively low velocity or is stationary, motion in second portion 212b may be acceptable.

Second portion 212b of conduit arrangement 212 may stretch, or otherwise move, when measurement stage 208 is not in close proximity to wafer stage 204. As shown, second portion 212b of conduit arrangement 212 stretches along a y-axis when measurement stage 208 is relatively far away from wafer stage 204 relative to the y-axis.

To reduce an acceleration requirement of a measurement stage relative to a y-axis, as well as to provide more space between the measurement stage and the exposure stage to reduce the risk of damage, a conduit arrangement coupled to a wafer stage may substantially attach to a slider arrangement on the measurement stage. In other words, a tube carrier assembly of a measurement stage may include a slider arrangement that effectively slides along the measurement stage. A slider arrangement may include a slider that holds a conduit arrangement and slides on a rail or a guide that is a part of, or is otherwise attached to, a measurement stage. It should be appreciated that if the motion of a slider does not create significant vibrations, a measurement stage may move with a lower acceleration during exposure, thereby reducing the heat load associated with the measurement stage and, hence, an overall stage apparatus. In one embodiment, substantially only the outboard end of a slider, or the end of the slider closest to a wafer stage, tracks the trajectory of the wafer stage. That is, the outboard end of the slider may track the trajectory of a wafer stage with a higher degree of accuracy, while the measurement stage may move with a lower degree of accuracy than the outboard end of the slider.

In one embodiment, when an exposure stage or a wafer stage and a measurement stage “scrum,” or move with substantially the same acceleration while remaining relatively close together, a slider may effectively retract, e.g., move away from the exposure stage or the wafer stage, as the two stages move closer together. When a scrum is completed, the measurement stage may move away from the exposure stage or the wafer stage, thereby allowing the slider to extend, e.g., to move towards the exposure stage or the wafer stage.

During some operations, a measurement stage may need to move further away from a wafer stage. For example, a measurement stage may need to be at a relatively large distance away from a wafer stage during a wafer loading process. During these less critical phases of wafer stage and/or measurement stage operations, disturbances caused by the movement of conduits are less likely to have a significant adverse effect on the operations. As such, a slider arrangement may allow conduits to move more freely during less critical phases of the operations.

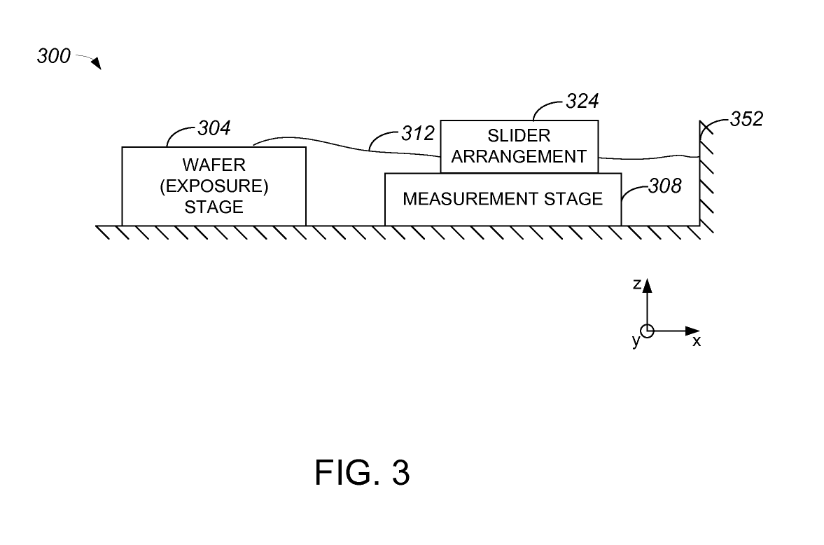

FIG. 3 is diagrammatic representation of an overall stage device within which a measurement stage with a slider arrangement supports at least one conduit associated with a wafer stage in accordance with an embodiment of the present invention. An overall stage device 300 includes a wafer or exposure stage 304, which is generally arranged to support a wafer (not shown), and a measurement stage 308. At least one cable or tube 312 or, more generally, at least one conduit, is substantially coupled between a ground 352 and wafer stage 304. Ground 352 may typically be any suitable surface that moves significantly less than wafer stage 304, e.g., a countermass. The at least one cable or tube 312 is arranged to supply, in one embodiment, electrical power and/or cooling to wafer stage 304. The at least one cable or tube 312 is arranged to be supported by a sliding arrangement 324 of measurement stage 308 such that the at least one cable or tube 312 is supported and moved by measurement stage 308 and a slider arrangement 324.

While the at least one cable or tube 312 may move when measurement stage 308 moves, the at least one cable or tube 312 may also move when a portion of slider arrangement 324 moves with respect to measurement stage 308. For example, when a slider (not shown) of slider arrangement 324 that is coupled to the at least one cable or tube 312 slides along measurement stage 308, the at least one cable or tube 312 moves with respect to measurement stage 308. In some instances, a slider (not shown) may be actuated using an actuator such as a linear motor, a voice coil motor (VCM), an electrical solenoid, and/or a pneumatic cylinder. It should be appreciated, however, that a slider (not shown) may be passive, and may include an actuated brake and/or a clamp mechanism. For an embodiment which utilizes a clamp mechanism, a clamp may be activated during exposure such that a slider (not shown) is fixed with respect to measurement stage 308. Such a clamp may be released when a slider (not shown) is to be extended or retracted, and the slider may be pushed by the relative motion of wafer stage 304 and measurement stage 308.

It should be appreciated that although slider arrangement 324 is shown as being on a top surface of measurement stage 308 relative to a z-axis, slider arrangement 324 may generally be carried or mounted on any suitable location on measurement stage 308. For example, slider arrangement 324 may be carried on a side surface of measurement stage 308. Slider arrangement 324 may extend and/or retract along at least one axis while substantially carrying the at least one cable or tube 312.

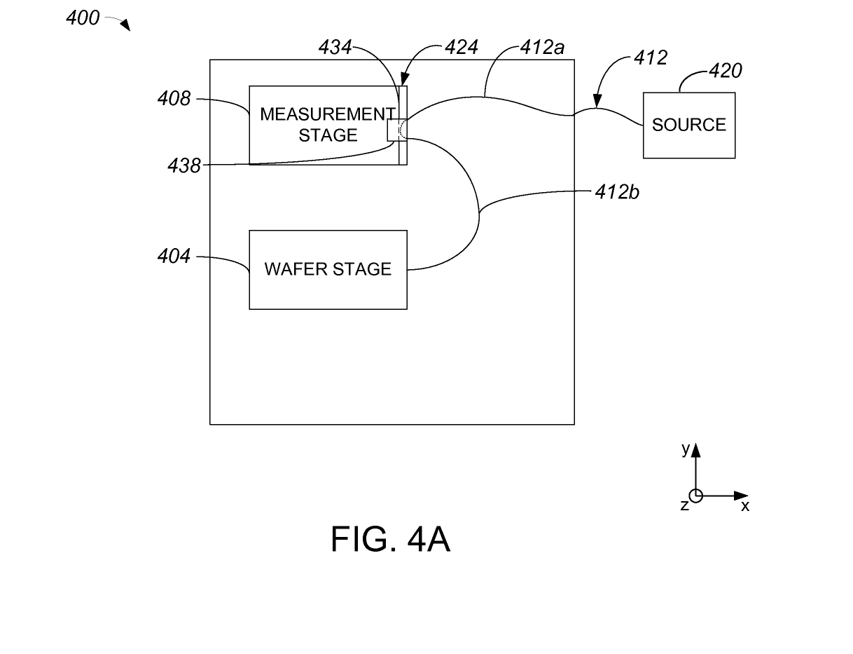

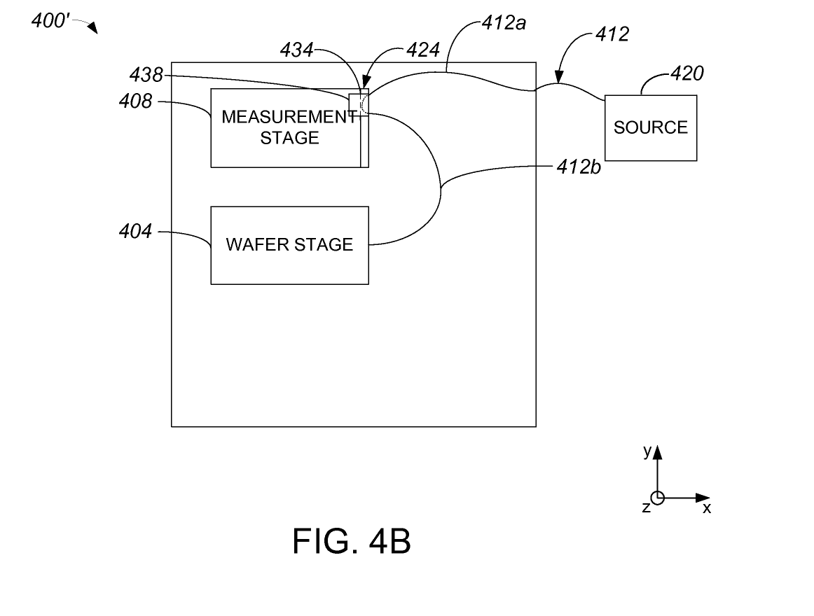

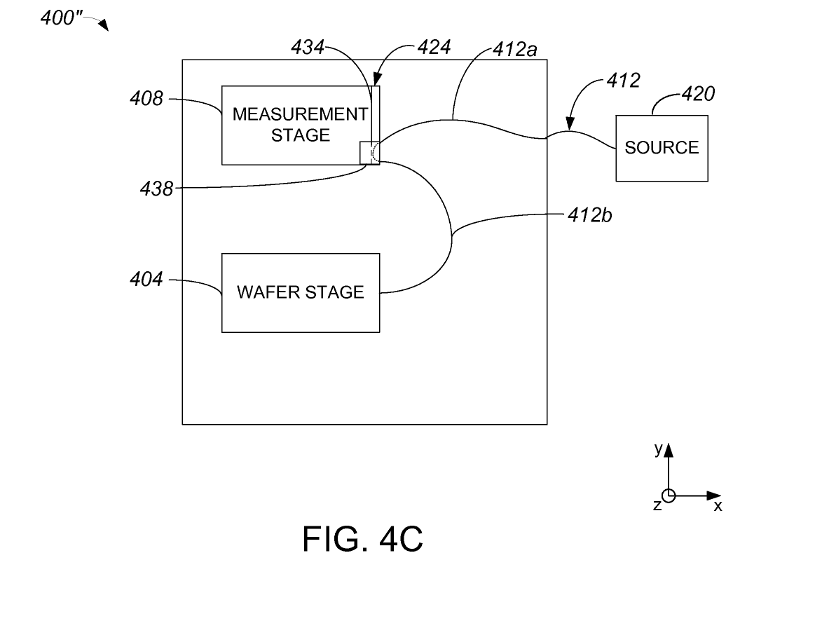

FIG. 4A is a diagrammatic top view representation of a wafer stage and a measurement stage in which the measurement stage supports a conduit using a slider arrangement in accordance with an embodiment of the present invention. An overall stage apparatus 400 includes a wafer stage 404 arranged to carry a wafer (not shown). In one embodiment, wafer stage 404 is driven by a planar motor (not shown). A measurement stage 408 is arranged follow wafer stage 404, e.g., is configured to translate and to accelerate with wafer stage 404.

At least one conduit arrangement 412, e.g., at least one cable or tube, may be arranged to essentially couple a source 420 to wafer stage 404. It should be appreciated that source 420 may effectively be a ground surface, or a surface of a countermass. Conduit arrangement 412 may provide fluid, e.g., cooling fluid, and/or power, e.g., electricity, from source 420 to wafer stage 404. A first portion 412a of conduit arrangement 412 is arranged between source 420 and measurement stage 408, while a second portion 412b of conduit arrangement 412 is arranged between measurement stage 408 and wafer stage 404.

A slider arrangement 424 is a part of, or is attached to, measurement stage 408. Slider arrangement 424 generally includes a rail 434 and a slider 438. In one embodiment, rail 434 is supported on, or is part of, measurement stage 408, while slider 438 is configured to slide along rail 434. As shown, slider 438 may slide on rail 434 in a y-direction. Conduit arrangement 412 is supported by, or otherwise carried on, slider 438. Thus, as slider 438 slides on rail 434 in a y-direction, conduit arrangement 412 moves in the y-direction.

In general, slider 438 may move with measurement stage 408, i.e., when measurement stage moves. Additionally, slider 438 may move with respect to measurement stage 408, e.g., slider 438 may slide or otherwise move along rail 434 even when measurement stage 408 is substantially stationary.

Slider 438 carries conduit arrangement 412 while substantially absorbing disturbance forces associated with first portion 412a of conduit arrangement 412. At least second portion 412b of conduit arrangement 412 may be relatively stiff, as slider 438 may slide to accommodate a change in distance between wafer stage 404 and measurement stage 408, even when measurement stage 408 is substantially stationary. As slider 438 may accommodate distance changes between wafer stage 404 and measurement stage 408, second portion 412b of conduit arrangement 412 may not have to contract and/or extend. Thus, second portion 412b of conduit arrangement 412 may be relatively stiff and, as a result, less likely to be subject to vibrations. It should be appreciated, however, that conduit arrangement 412 may instead be relatively flexible.

In one embodiment, slider 438 may be arranged substantially only to allow wafer stage 404 and measurement stage 408 to separate when separation is needed while allow the length of second portion 412b to be relatively short. That is, in one embodiment, slider 438 is not used to track wafer stage 404, and the overall motion of measurement stage 408 may be used to track slider 438.

When wafer stage 404 is in relatively close proximity to measurement stage 408, as shown, a distance between wafer stage 404 and measurement stage 408 may be substantially minimized when slider 438 is as far from wafer stage 404 as possible. FIG. 4B is a diagrammatic top view representation wafer stage 404 and measurement stage 408 in relatively close proximity at a time t1, when a distance between wafer stage 404 and measurement stage 408 is substantially minimized in accordance with an embodiment of the present invention. Slider 438 is positioned near a side of measurement stage 408 that is furthest from wafer stage 404. In general, slider 438 moves towards the side of measurement stage 408 that is furthest from wafer stage 404 when wafer stage 404 and measurement stage 408 are in relatively close proximity to each other. As shown, second portion 412b of conduit arrangement 412 may form a loop.

FIG. 4C is a diagrammatic top view representation of wafer stage 404 and measurement stage 408 at a time t2 at which wafer stage 404 and measurement stage 408 are relatively far apart in accordance with an embodiment of the present invention. When wafer stage 404 and measurement stage 408 are relatively far apart, as for example during a wafer loading process, slider 438 may be located along rail 434 such that loop formed by second portion 412b remains substantially the same as it was at time t1, as shown in FIG. 4B. That is, the loop formed by second portion 412b may be substantially the same regardless of a position of slider 438 along rail 434, provided that slider 438 and wafer stage 404 move together in a direction along a y-axis.

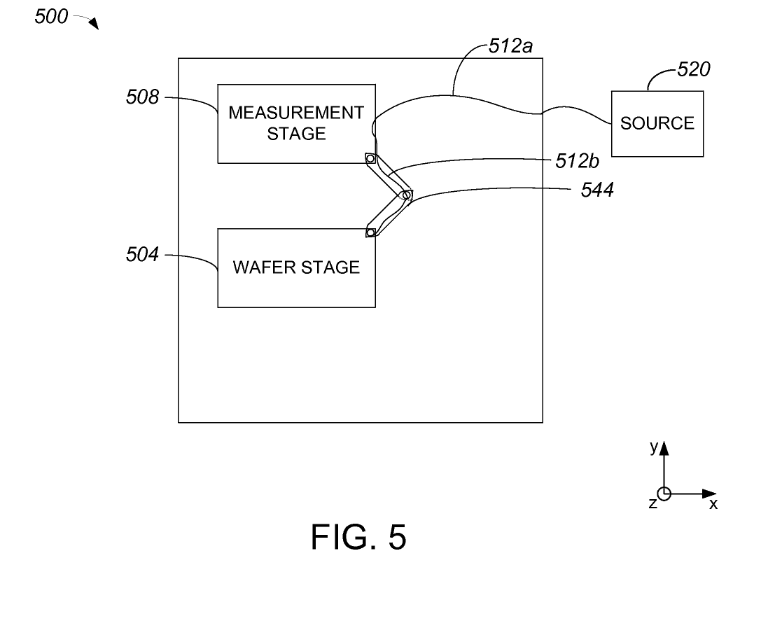

In one embodiment, a coupling may be present between a wafer stage and a measurement stage, and arranged to further support a conduit that is carried by the measurement stage. The coupling may be, but is not limited to being, a linkage. FIG. 5 is diagrammatic top view representation of an overall stage device within which a measurement stage with an associated linkage supports at least one conduit associated with a wafer stage in accordance with an embodiment of the present invention. An overall stage device 500 includes a wafer stage 504 arranged to carry a wafer (not shown). In one embodiment, wafer stage 504 is driven by a planar motor (not shown). A measurement stage 508 is arranged to follow wafer stage 508, e.g., to translate and to accelerate with wafer stage 504.

At least one conduit arrangement 512 effectively couples a source 520 to wafer stage 504. Source 520 may effectively be a ground, e.g., a countermass. Conduit arrangement 512 may provide fluid, e.g., cooling fluid, and/or power, e.g., electricity, from source 520 to wafer stage 504. A first portion 512a of conduit arrangement 512 is arranged between source 520 and measurement stage 508, while a second portion 512b of conduit arrangement 512 is arranged between measurement stage 508 and wafer stage 504.

Second portion 512b of conduit arrangement 512 is supported on a linkage 544 that is coupled on one end to measurement stage 508 and on another end to wafer stage 504. Linkage 544, which may include any number of links coupled by joints, may be arranged to substantially secure conduit arrangement 512 to measurement stage 508 such that conduit arrangement 512 may move with measurement stage 508. Linkage 544 may expand when wafer stage 504 moves away from measurement stage 508, as for example during a wafer loading operation. It should be appreciated that linkage 544 may be driven by actuators, or linkage 544 may be passive. Supporting second portion 512b with linkage 544 may reduce unwanted vibrations or disturbances within second portion 512b when stage 504 and stage 508 accelerate.

As previously mentioned with respect to FIGS. 2A-C, a tube carrier arrangement may be mounted on a measurement stage to carry at least one conduit such that the affect of disturbances associated with the at least one conduit on a wafer stage may be reduced. FIGS. 6A and 6B are diagrammatic representation of a measurement stage on which a tube carrier arrangement is mounted in accordance with an embodiment of the present invention. A tube carrier arrangement 624 may be mounted on a surface, as for example a side surface, of a measurement stage 608. Tube carrier arrangement 624 is generally configured to hold at least one conduit. In the described embodiment, tube carrier arrangement 624 is arranged to hold a plurality of hoses 662 that are effectively joined together in a ribbon configuration, as well as an electrical cable 674. It should be understood, however, that tube carrier arrangement 624 may generally be configured to hold any number of conduits or any suitable size.

Tube carrier arrangement 624, which may be formed from a material such as plastic or metal, may be molded or otherwise machined to securely hold hoses 662 and cable 674 such that hoses 662 and cable 674 may pass through tube carrier arrangement 624 while being securely held. As shown, a first piece 678a of tube carrier arrangement 624 may hold hoses 662, while a second piece 678b of tube carrier arrangement 624 may hold cable 674. First piece 678a and second piece 678b may be secured to measurement stage 608 using fasteners 682, e.g., bolts.

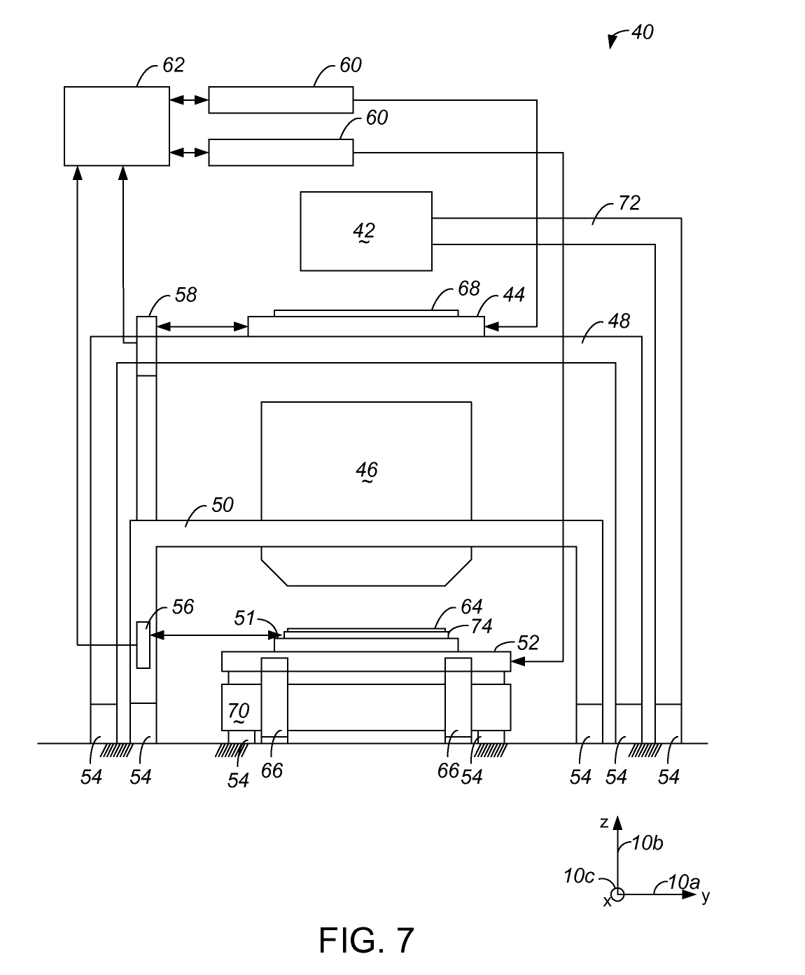

With reference to FIG. 7, a photolithography apparatus which may include a stage assembly that uses a measurement stage to carry cables and tubes will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an EI-core actuator. The planar motor which drives wafer positioning stage 52 generally uses an electromagnetic force generated by magnets and corresponding armature coils arranged in two dimensions.

A wafer 64 is held in place on a wafer holder or chuck 74 which is coupled to wafer table 51. Wafer positioning stage 52 is arranged to move in multiple degrees of freedom, e.g., in up to six degrees of freedom, under the control of a control unit 60 and a system controller 62. In one embodiment, wafer positioning stage 52 may include a plurality of actuators and have a configuration as described above. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In one described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, which may provide a beam of light that may be reflected off of a reticle. In one embodiment, illumination system 42 may be arranged to project a radiant energy, e.g., light, through a mask pattern on a reticle 68 that is supported by and scanned using a reticle stage 44 which may include a coarse stage and a fine stage, or which may be a single, monolithic stage. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F2-type laser (157 nm). Alternatively, illumination system 42 may also use charged particle beams such as x-ray and electron beams. For instance, in the case where an electron beam is used, thermionic emission type lanthanum hexaboride (LaB6) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser are used, glass materials such as quartz and fluorite that transmit far ultra-violet rays is preferably used. When either an F2-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave minor. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave minor, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

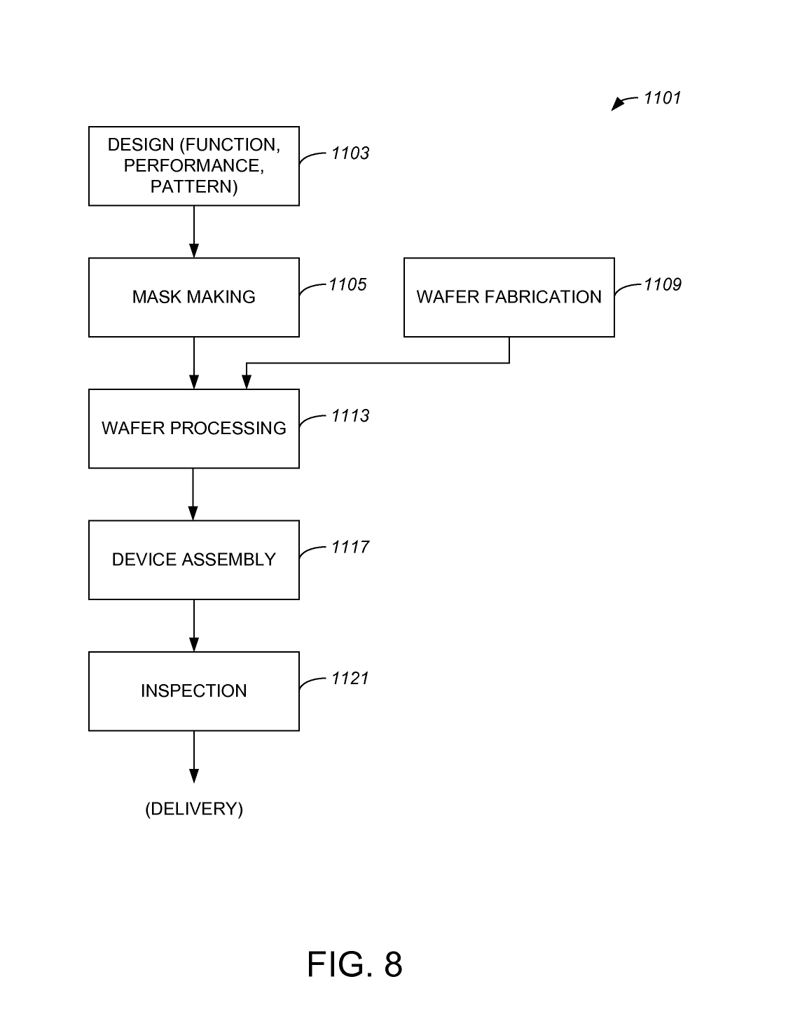

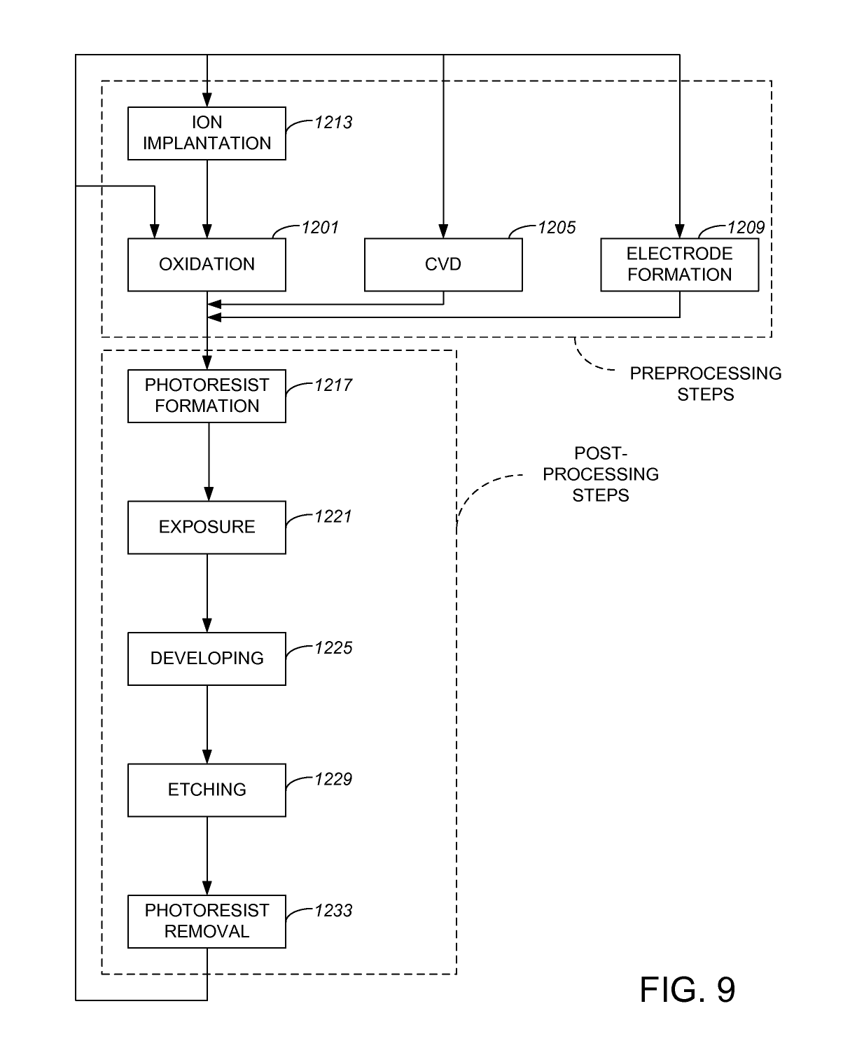

Further, semiconductor devices may be fabricated using systems described above, as will be discussed with reference to FIG. 8. FIG. 8 is a process flow diagram which illustrates the steps associated with fabricating a semiconductor device in accordance with an embodiment of the present invention. A process 1101 of fabricating a semiconductor device begins at step 1103 in which the function and performance characteristics of a semiconductor device are designed or otherwise determined. Next, in step 1105, a reticle or mask in which has a pattern is designed based upon the design of the semiconductor device. It should be appreciated that in a substantially parallel step 1109, a wafer is typically made from a silicon material. In step 1113, the mask pattern designed in step 1105 is exposed onto the wafer fabricated in step 1109. One process of exposing a mask pattern onto a wafer will be described below with respect to FIG. 9. In step 1117, the semiconductor device is assembled. The assembly of the semiconductor device generally includes, but is not limited to including, wafer dicing processes, bonding processes, and packaging processes. Finally, the completed device is inspected in step 1121. Upon successful completion of the inspection in step 1121, the completed device may be considered to be ready for delivery.

FIG. 9 is a process flow diagram which illustrates the steps associated with wafer processing in the case of fabricating semiconductor devices in accordance with an embodiment of the present invention. In step 1201, the surface of a wafer is oxidized. Then, in step 1205 which is a chemical vapor deposition (CVD) step in one embodiment, an insulation film may be formed on the wafer surface. Once the insulation film is formed, then in step 1209, electrodes are formed on the wafer by vapor deposition. Then, ions may be implanted in the wafer using substantially any suitable method in step 1213. As will be appreciated by those skilled in the art, steps 1201-1213 are generally considered to be preprocessing steps for wafers during wafer processing. Further, it should be understood that selections made in each step, e.g., the concentration of various chemicals to use in forming an insulation film in step 1205, may be made based upon processing requirements.

At each stage of wafer processing, when preprocessing steps have been completed, post-processing steps may be implemented. During post-processing, initially, in step 1217, photoresist is applied to a wafer. Then, in step 1221, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1225. Once the exposed wafer is developed, parts other than residual photoresist, e.g., the exposed material surface, may be removed by etching in step 1229. Finally, in step 1233, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, while a measurement stage may support cables such as electrical cables and tubes such as coolant tubes, a measurement stage may generally support any suitable cables, tubes, hoses, and/or wires. Further, while utilizing a measurement stage to support cables and hoses has generally been described in the context of a wafer stage or exposure stage, a measurement stage may be used to support cables and hoses associated with any suitable stage, e.g., a reticle stage.

For an embodiment in which a measurement stage includes a slider, in addition to allowing freer movement of conduits coupled to the slider, it should be appreciated that the trajectory of a wafer stage may be precisely tracked by substantially only an outboard end of the slider. As such, the measurement stage may track the wafer stage less precisely, while the outboard end of the slider tracks the wafer stage precisely.

Tube carrier assembly 624, as shown in FIGS. 6A and 6B, has been described as being mounted on a measurement stage. In one embodiment, tube carrier assembly 624 may be incorporated as part of a slider. That is, a mechanism similar to tube carrier assembly 624 may allow cables and/or tubes to be coupled to a slider associated with a measurement stage.

In one embodiment, a clamp may effectively reach out from a measurement stage such as measurement stage 208 of FIGS. 2A-C. When wafer stage 204 and measurement stage 208 are moving relatively close together, as shown in FIG. 2B, such a clamp may essentially grab second portion 212b near wafer stage 204. As a result, second portion 212b may be supported, and the existence of a potentially sizeable unsupported loop which may cause vibrations in wafer stage 204 may be substantially eliminated. When a clamp is associated with measurement stage 208, the clamp may release second portion 212b to allowing wafer stage 204 and measurement stage 208 to move further apart, e.g., into the configuration shown in FIG. 2C.

The operations associated with the various methods of the present invention may vary widely. For instance, steps may be added, removed, altered, combined, and reordered without departing from the spirit or the scope of the present invention.

The many features of the embodiments of the present invention are apparent from the written description. Further, since numerous modifications and changes will readily occur to those skilled in the art, the present invention should not be limited to the exact construction and operation as illustrated and described. Hence, all suitable modifications and equivalents may be resorted to as falling within the spirit or the scope of the present invention.

What is claimed is:

1. A stage apparatus comprising:
a wafer stage;
at least one conduit, the at least one conduit being coupled between the wafer stage and one selected from a group including a ground and a countermass; and
a measurement stage, the measurement stage being configured to approximately follow the wafer stage during at least a portion of a motion of the wafer stage, wherein the measurement stage is configured to carry the at least one conduit to reduce disturbances on the wafer stage caused by the at least one conduit.

2. The stage apparatus of claim 1 wherein the at least one conduit includes at least one selected from a group including a hose, a tube, a cable, and a wire.

3. The stage apparatus of claim 1 wherein the measurement stage includes a tube carrier assembly arranged to couple the at least one conduit to the measurement stage.

4. The stage apparatus of claim 3 wherein the tube carrier assembly is a slider arrangement, the slider arrangement including a rail and a slider configured to slide along the rail, and wherein the at least one conduit is coupled to the slider.

5. The stage apparatus of claim 3 wherein the tube carrier assembly includes a linkage, the linkage being configured to extend and to retract, and wherein the at least one conduit is coupled to the linkage.

6. The stage apparatus of claim 1 wherein the measurement stage is configured to perform measurements of system characteristics associated with the stage apparatus.

7. The stage apparatus of claim 1 further including:
a planar motor, wherein the planar motor is configured to drive at least one of the wafer stage and the measurement stage.

8. An exposure apparatus comprising the stage apparatus of claim 1.

9. A wafer formed using the exposure apparatus of claim 8.

10. A stage apparatus comprising:
a first stage;
at least one selected from a group including a cable and a tube, the at least one selected from the group including the cable and the tube being coupled between the first stage and one selected from a group including a ground and a countermass; and
a second stage, the second stage being configured to follow the first stage at a first time during an overall exposure process when the first stage travels and to perform measurements, wherein the second stage is further configured to carry the at least one selected from the group including the cable and the tube to reduce disturbances on the first stage caused by the at least one selected from the group including the cable and the tube.

11. The stage apparatus of claim 10 wherein the second stage is configured to include a tube carrier arrangement, the tube carrier arrangement being configured to support the at least one selected from the group including the cable and the tube.

12. The stage apparatus of claim 11 wherein the tube carrier arrangement includes a slider, the slider being arranged to carry the at least one selected from the group including the cable and the tube, the slider further being configured to slide along the second stage.

13. The stage apparatus of claim 10 wherein the second stage is further configured to accelerate with the first stage at least during the first time.

14. The stage apparatus of claim 10 further including:
a planar motor, wherein the planar motor is configured to drive at least one of the first stage and the second stage.

15. An exposure apparatus comprising the stage apparatus of claim 10.

16. A wafer formed using the exposure apparatus of claim 15.

17. A method for operating a stage apparatus, the stage apparatus including a wafer stage and a measurement stage, the measurement stage being configured to take measurements of system characteristics, the method comprising:
scanning the wafer stage, wherein scanning the wafer stage causes a conduit between the wafer stage and a ground to move; and
moving the measurement stage such that the measurement stage follows the wafer stage while scanning the wafer stage, wherein the measurement stage is configured to support the conduit to reduce disturbances associated with the conduit when the conduit moves due to scanning the wafer stage.

18. The method of claim 17 wherein the measurement stage includes a tube carrier, the tube carrier having a rail and a slider arranged to slide on the rail, the slider being configured to support the conduit.

19. The method of claim 18 further including:
sliding the slider on the rail, wherein sliding the slider on the rail causes the conduit to move with the wafer stage.

20. The method of claim 19 wherein the slider is arranged to reduce an acceleration of the measurement stage while scanning the wafer stage.

21. The method of claim 17 wherein the conduit is coupled to the measurement stage between the ground and the wafer stage.
